(19) United States
(12) Patent Application Publication
(10) Pub. No.: US 2024/0256740 A1
(43) Pub. Date: Aug. 1, 2024

(54) FOUNDATION SCOUR FLUID-SOLID-SOIL COUPLING SIMULATION METHOD BASED ON SPH-DEM COUPLING AND MULTIPHASE FLOW THEORY

(71) Applicant: SOUTHEAST UNIVERSITY, Nanjing, Jiangsu (CN)

(72) Inventors: Wen XIONG, Nanjing, Jiangsu (CN); Rongzhao ZHANG, Nanjing, Jiangsu (CN)

(21) Appl. No.: 18/546,570

(22) PCT Filed: Dec. 28, 2022
(86) PCT No.: PCT/CN2022/142693

§ 371 Date: Aug. 15, 2023

(30) Foreign Application Priority Data
Nov. 11, 2022 (CN) 202211417631.4

(51) Int. Cl. G06F 30/25; G06F 17/11; G06F 30/28

(52) U.S. Cl. CPC G06F 30/25; G06F 17/11; G06F 30/28; G06F 2111/10

(57) ABSTRACT

The present disclosure discloses a foundation scour fluid-solid-soil coupling simulation algorithm based on SPH-DEM coupling and a multiphase flow theory, including: constructing a particle model, setting fluid particles and bed material particles based on the multiphase flow theory, and setting rigid particles based on a DEM theory; correcting a fluid control equation based on a fluid-solid coupling theory, and solving governing equations of the fluid particles; solving governing equations of DEM rigid particles by introducing fluid-solid coupling force, introducing fluid-soil and soil-solid coupling force to correct a sediment incipient motion model, based on a sediment Shield criterion, and solving foundation scour governing equations; and finishing a time step and entering next cycle. The present disclosure introduces a plurality of structure and state models through secondary development based on the SPH-DEM coupling and the multiphase flow theory, thereby realizing refined numerical simulation of foundation scour fluid-solid-soil coupling.

### TECHNICAL FIELD

The present disclosure relates to a scour simulation method based on SPH-DEM coupling and a multiphase flow theory and considering fluid-solid coupling, and particularly relates to a secondary development based on an SPH multiphase flow algorithm, introduces a DEM calculation theory and a plurality of experimental criteria to perform real-time refined simulation in the whole fluid-solid-soil coupling process during scouring, and belongs to the field of numerical simulation calculation.

### BACKGROUND

The scouring of bridge foundations is one of prime reasons for structural function failures and a loss of safety performance of the bridges at present, which has attracted widespread attention from numerous scholars. Numerical simulation is still one of the most effective methods for studying bridge scouring, which has many advantages of low cost, high efficiency, short cycle, etc. The current main algorithm is to solve N-S fluid control equations based on an Euler form to obtain fluid dynamic force, and by introducing a numerical bed material transport model, a numerical solution of bed surface elevation changes is obtained. However, it is difficult for an Euler-based numerical simulation method to converge when problems such as complex fluid surface fragmentation, waves and tsunami overflow are solved, or long time or a large number of resources are required for solving, and there is no real soil model, leading to difficulty in soil evolution track tracing; and an existing numerical model basically processes a scouring foundation as a fixed boundary, there are almost no studies for analysis on foundation stability from scouring hollowing in real time, there are also no cases considering influences on sediment incipient motion from foundation extrusion force, and there is a lack of an effective tool for simulating a fluid-solid-soil multi-field coupling effect under the situation of foundation scouring studying.

The smoothed particle hydrodynamics (SPH) method is a numerical solution method based on the Lagrangian form, and compared with the Euler method, particles have mass in themselves, which ensures conservation of mass without additional calculations; and when complex free surface flow is simulated, there is no need to trace fluid boundaries or different fluid interfaces. When the scouring problem is simulated, the soil model can be constructed, and there is no need to introduce a numerical sediment transport model, thereby further increasing efficiency and improving precision; and a discrete element method (DEM) algorithm also belongs to the numerical solution method based on the Lagrangian form, and is usually used to simulate non-linear mechanical behaviors such as structure large deformation and fragmentation, which has good compatibility with SPH. However, at present, there are few research and application cases about scour simulation based on SPH-DEM coupling, and there is a lack of design schemes for related algorithms, which are urgent to be further solved.

### SUMMARY

The present disclosure aims to solve the technical problems: based on an SPH-DEM coupling and multiphase flow theory and considering fluid-solid coupled calculation, a plurality of theories or experimental criteria are introduced to perform refined simulation of the whole fluid-solid-soil coupling process under the situation of foundation scouring, thereby realizing real-time analysis of foundation dynamic response under scour hollowing; and influences on sediment incipient motion from foundation extrusion force are considered, such that the characteristics of easy procedural implementation, high precision and operability, etc. are achieved.

The present disclosure adopts the following technical solution for solving the above technical problems:

A foundation scour fluid-solid-soil coupling simulation method based on SPH-DEM coupling and a multiphase flow theory includes following steps:
step 1: constructing a particle model, setting fluid particles and bed material particles based on the multiphase flow theory, and setting rigid particles based on a DEM theory, where specific steps include as below:
step 1.1: respectively constructing a fluid particle model and a soil particle model based on a multiphase flow basic principle, setting the fluid particle model as Newtonian fluid, setting the soil particle model as non-Newtonian fluid, and determining a soil viscosity μ_{HBP} based on an HBP model,

$${μ}_{HBP} = \frac{\vert {τ}_{c} \vert}{\sqrt{{II}_{D}}} [ 1 - {e}^{- m \sqrt{{II}_{D}}} ] + 2 μ {\vert 4 {II}_{D} \vert}^{\frac{n - 1}{2}}$$

where τ_{c} denotes yield stress of a model material, II_{D} denotes a second invariant of a fluid strain rate tensor, m denotes a stress exponent growth coefficient, μ denotes a water viscosity, and n denotes an exponent associated with shear stress;
step 1.2: introducing a DP yield criterion to calculate specific material yield stress τ_{y};
step 1.3: substituting the specific material yield stress τ_{y} obtained in step 1.2 into the calculation formula of the soil viscosity μ_{HBP} in step 1.1 to replace the model material yield stress τ_{c}, and establishing a soil viscosity calculation model;
step 1.4: setting the rigid particles based on the DEM theory, and determining a normal contact rigidity Kₙ, normal contact damping γₙ, a tangential contact rigidity Kₜ and tangential contact damping γₜ among the rigid particles; and
step 1.5: calculating normal contact force Fₙ and tangential contact force based on the normal contact rigidity Kₙ, the normal contact damping γₙ, the tangential contact rigidity Kₜ and the tangential contact damping γₜ among the rigid particles obtained in step 1.4;
step 2: introducing a fluid-solid coupling theory based on the particle model obtained in step 1 to correct a fluid control equation, and performing controlled solving of the fluid particles, where specific steps include as below:
step 2.1: introducing particle fluid-solid coupling force F_{fs}, and correcting a fluid momentum conservation equation; and
step 2.2: giving a discrete form of the fluid momentum conservation equation obtained in step 2.1, based on a kernel function theory of an SPH algorithm;
step 3: based on the particle model obtained in step 1, correcting and solving the rigid particle control equation by combining the Newton's second law and considering the particle fluid-solid coupling force F_{fs} obtained in step 2;
step 4: based on the particle model obtained in step 1, introducing a sediment particle Shield criterion, correcting a sediment incipient motion model in combination with the fluid-soil coupling force obtained in step 1 and the solid-soil coupling force obtained in step 2, and performing foundation scour controlled solving, where specific steps include as below:
step 4.1: based on the fluid particle velocity u obtained based on the momentum equation in step 2, introducing an Einstein logarithmic flow velocity distribution formula to calculate fluid shear stress τ_{b} exerted on soil particles;
step 4.2: based on the soil particle viscosity μ_{HBP} model obtained in step 1.1, introducing the sediment particle Shield criterion to calculate sediment incipient motion critical stress τ_{cr,0};
step 4.3: based on the sediment incipient motion critical stress τ_{cr,0} obtained in step 4.2, introducing the fluid-solid coupling force F_{fs} of the sediment particles and the rigid particles obtained in step 2 to calculate corrected sediment incipient motion critical stress Ter considering an external load and a side slope effect;
step 4.4: judging the incipient motion state of the sediment particles based on the fluid shear stress Tb obtained in step 4.1 and the corrected sediment incipient motion critical stress τ_{cr} obtained in step 4.3, where if τ_{cr}≤τ_{b} is satisfied, τ_{cr} is substituted into the formula in step 1.1 to replace the yield stress τ_{c}, a bed material particle viscosity μ_{HBP} is updated to make the bed material particle into a bed load particle, and if the condition is not satisfied, processing is performed according to step 1.2 and step 1.3;
step 4.5: according to the bed load particles obtained in step 4.4, introducing a Mastbergen formula to calculate a critical flow velocity μ_{lift} at which a bed load is converted into a suspended load, where if a flow velocity μ≥μ_{lift} of the fluid particles is satisfied, the fluid particles are converted into suspended load particles, and an equivalent viscosity μ_{lift} is calculated to replace the bed material particle viscosity μ_{HBP}, and if the condition is not satisfied, no processing is performed; and
step 4.6: according to the suspended load particles obtained in step 4.5, introducing the Mastbergen formula to calculate a critical flow velocity μₛₑₜ at which the suspended load is converted into the bed load, where if the actual flow velocity μ≤μₛₑₜ of the particles is satisfied, the particles are converted into the bed load particles and processed according to step 4.4, and if the condition is not satisfied, no processing is performed; and
step 5: repeating step 1 to step 4 until solving is completed.
Instep 1.2, the material yield stress τ_{y} is calculated as below:

$$\vert {τ}_{y} \vert = α p + β$$

where p denotes hydrostatic pressure exerted on saturated sediment particles, and α and β are given by Mohr-Coulomb yield criterion parameters, and calculation formulas are as below:

$$α = \frac{2 sin θ}{\sqrt{3} ( 3 - sin θ )} , β = \frac{6 c sin θ}{\sqrt{3} ( 3 - sin θ )}$$

where θ denotes an internal friction angle, and c denotes soil cohesion.

In step 1.4, the normal contact rigidity Kₙ, the normal contact damping γₙ, the tangential contact rigidity Kₜ and the tangential contact damping γₜ among the rigid particles are calculated as below:

$$\{ \begin{matrix}{K}_{n , ij} = \frac{4}{3} {E}^{*} \sqrt{{R}^{*}} ; {γ}_{n , ij} = {C}_{n} \sqrt{6 {M}^{*} {E}^{*} \sqrt{{R}^{*}}} ; \\ {K}_{t , ij} = \frac{2}{7} {K}_{n , ij} ; {γ}_{t , ij} = \frac{2}{7} {γ}_{n , ij}\end{matrix}$$

where Cₙ=1*10⁻⁵, K_{n,ij} denotes the normal contact rigidity between the DEM rigid particle i and the rigid particle j, and K_{t,ij}, γ_{n,ij} and γ_{t,ij} are defined in the same way; and E* denotes an equivalent elasticity modulus, R* denotes an equivalent particle radius, and M* denotes an equivalent mass, which are respectively calculated as below:

$$\frac{1}{{E}^{*}} = \frac{1 - {μ}_{i}^{2}}{{E}_{i}} + \frac{1 - {μ}_{j}^{2}}{{E}_{j}} ; {R}^{*} = \frac{{r}_{i} {r}_{j}}{{r}_{i} + {r}_{j}} ; {M}^{*} = \frac{{m}_{i} {m}_{j}}{{m}_{i} + {m}_{j}}$$

where Eᵢ and Eⱼ respectively denote the elasticity modulus of the material assigned by the DEM rigid particle i and the rigid particle j;

μᵢ and μⱼ respectively denote the Poisson's ratio of the material assigned by the DEM rigid particle i and the rigid particle j;

rᵢ and rⱼ respectively denote the radius of the DEM rigid particle i and the radius of the rigid particle j; and

mᵢ and mⱼ respectively denote the mass of the DEM rigid particle i and the mass of the rigid particle j.

In step 2.1, the fluid momentum conservation equation is corrected as:

$$\frac{du}{dt} = - \frac{1}{ρ} ∇ P + υ {∇}^{2} u + g + {F}_{fs}$$

where in the equation, u denotes a fluid velocity vector, P is a fluid pressure item, v denotes a fluid viscosity, g is a fluid gravity item, and the rest of symbols are the same as above.

In step 2.2: the discrete form of the control equation obtained in step 2.1 is:

$$\frac{{du}_{a}}{dt} = - {\sum }_{b} {m}_{b} ( \frac{{P}_{b} + {p}_{a}}{{ρ}_{b} \cdot {ρ}_{a}} ) {∇}_{a} {W}_{ab} + g + {\sum }_{b} {m}_{b} ( \frac{4 {μ}_{0} {r}_{ab} \cdot {∇}_{a} {W}_{ab}}{( {ρ}_{a} + {ρ}_{b} ) ( {r}_{ab}^{2} + {η}^{2} )} ) {u}_{ab} + {\sum }_{b} {m}_{b} ( \frac{{τ}_{ij}^{b}}{{ρ}_{b}^{2}} + \frac{{τ}_{ij}^{a}}{{ρ}_{a}^{2}} ) {∇}_{a} {W}_{ab} + {m}_{s} {\sum }_{f} {m}_{f} ( \frac{{P}_{s}}{{ρ}_{s}^{2}} + \frac{{P}_{f}}{{ρ}_{f}^{2}} ) {∇}_{s} {W}_{sf}$$

where ∇ is a Hamiltonian operator, the subscript α denotes a center particle, the subscript b denotes a neighbor particle, W_{ab} is a kernel function

$$W ( {r}_{a} - {r}_{b} , h ) = \frac{21}{16 π {h}^{3}} {( 1 - \frac{q}{2} )}^{4} ( 2 q + 1 ) 0 \leq q \leq 2$$

with a particle a as a retrieval center, rₐ and r_{b} respectively denote position vectors of the center particle and the neighbor particle, q is a ratio of a particle spacing to a smooth length, and h denotes the smooth length;

μ₀ denotes a motion viscosity;
τᵢⱼ denotes a fluid SPS stress vector;
m_{f} and P_{f} respectively denote the mass and the pressure of fluid particles searched within the kernel function radius by a rigid particle s,
mₛ and Pₛ respectively denote the equivalent mass and the pressure of the rigid particles,

$${m}_{s} = {\sum }_{f} \frac{{m}_{f}^{2}}{{ρ}_{f}} {W}_{sf} and {P}_{s} = {\sum }_{f} \frac{{m}_{f} {P}_{f}}{{ρ}_{f}} {W}_{sf} ; and$$

the rest of variables are the same as above.

In step 3, the rigid particle control equation is corrected as:

$${m}_{a} \frac{{dv}_{a}}{dt} = G + {F}_{fs} + {F}_{n} + {F}_{t}$$

where mₐ and vₐ respectively denote a mass and a velocity vector of the rigid particle a, G denotes a gravity vector of the rigid particle a, and the rest of symbols are the same as above.

Instep 4.1, the fluid shear stress τ_{b} is calculated as:

$$\frac{{τ}_{b}}{ρ} = ( κ {d}^{2} ) {( \frac{Δ u}{d} )}^{2}$$

where d denotes a characteristic particle size of the particles; Δu denotes a velocity difference of sediment particles and nearby water particles, κ denotes a von Karman constant being 0.41, and ρ denotes a sediment particle density.

Instep 4.2, the calculation formula of the sediment incipient motion critical stress τ_{cr,0} is:

$${τ}_{cr , 0} = {θ}_{cr} \cdot ( {ρ}_{s} - ρ ) gd$$

where θ_{cr} denotes a critical Shields parameter only related to sediment parameters, ρₛ denotes a saturated sediment density, ρ denotes a water density, g denotes a gravitational acceleration, and d denotes a particle size of the soil particles.

Instep 4.3, the corrected sediment incipient motion critical stress τ_{cr} is calculated as:

$$\frac{{τ}_{cr}}{{τ}_{cr , 0}} =$$

$$\frac{\begin{matrix}\sqrt{{( {f}_{1} + η {tan}^{2} ϕ {f}_{2} )}^{2} + ( 1 - {η}^{2} {tan}^{4} ϕ ) {f}_{2}^{2} + ( 1 - {η}^{2} {tan}^{2} ϕ ) {f}_{3}^{2}} - \\ η {tan}^{2} ϕ {f}_{1} - {f}_{2}\end{matrix}}{( 1 - η tan ϕ ) W}$$

$$\{ \begin{matrix}{f}_{1} = W cos γ - \vec{P} \cdot \vec{n} \\ {f}_{2} = \vec{P} \cdot \vec{f} - W \cdot {w}_{z} \\ {f}_{3} = \vec{P} + W sin γ \vec{{e}_{wt}}\end{matrix}$$

where P is a modulus of F_{fs}, η=0.7, \vec{ƒ} is a unit vector in a flow velocity direction, W denotes gravity exerted on the sediment particles, α, β, and γ respectively denote an included angle between a slope surface normal vector and an X-axis direction, an included angle between the slope surface normal vector and a Y-axis direction, and an included angle between the slope surface normal vector and a Z-axis direction,

$$\vec{n} = \frac{1}{} ( tan α , tan β , 1 ) ,$$

[symbol]

\sqrt{1+tan²α+tan²β}=(cosγ)⁻¹, wᵢ is a component of \vec{ƒ} in the X-axis direction, the Y-axis direction and the Z-axis direction, \vec{e_{wt}} is a unit vector component of the gravity in a slope surface direction, and ∅ denotes an internal friction angle of the sediment particles.

In step 4.5, the critical flow velocity μ_{lift} at which the bed load is converted into the suspended load is calculated as:

$${u}_{lift} = {α}_{i} {n}_{s} {{d}_{*}^{0.3} ( {θ}_{b} - {θ}_{cr} )}^{1.5} \sqrt{\frac{d ( {ρ}_{s} - ρ ) g}{ρ}}$$

where αᵢ denotes a sediment transport coefficient, nₛ denotes a bed surface normal vector, d. denotes a sediment particle size coefficient,

$${d}_{*} = {{d}_{50} [ \frac{ρ ( {ρ}_{s} - ρ ) g}{{μ}^{2}} ]}^{1 / 3} ,$$

ρₛ denotes a saturated sediment density, ρ denotes a water density, g denotes a gravitational acceleration, d denotes a particle size of the soil particles, θ_{b} denotes an actual Shields parameter of the soil particles, and θ_{cr} denotes a critical Shields parameter.

The equivalent viscosity μ_{lift} is calculated as:

$${μ}_{lift} = μ e \frac{0.5 {C}_{v}}{1 - \frac{39}{64} {C}_{v}}$$

where μ denotes a water viscosity, and Cᵥ denotes a sediment particle concentration within the kernel function radius; and

Instep 4.6, the calculation formula of the critical flow velocity μₛₑₜ is:

$${u}_{set} = \frac{μ}{d} [ {( {10.36}^{2} + 1.049 {d}_{*}^{3} )}^{0.5} - 10.36 ]$$

where μ denotes a water viscosity, d denotes a particle size of the soil particles, and d. denotes a sediment particle size coefficient.

Compared with the Prior Art, the Present Disclosure has Following Beneficial Effects by Adopting the Above Technical Solution:
1. The present disclosure introduces, based on SPH-DEM coupling and the multiphase flow theory and considering the fluid-solid coupled calculation, the plurality of theories or experimental criteria to perform real-time refined simulation of the whole fluid-solid-soil coupling process under the situation of foundation scouring, thereby realizing real-time analysis of foundation dynamic response under scouring; and considers influences on sediment incipient motion from foundation extrusion force, and has the characteristics of easy procedural implementation, high precision and operability, etc.
2. The present disclosure realizes scouring numerical simulation based on SPH multiphase flow secondary development, and the particles have mass, which ensures conservation of mass without additional calculations; and when the scour problem is simulated, a soil model can be constructed, and there is no need to introduce a numerical sediment transport model, thereby further improving efficiency and precision.
3. The present disclosure really achieves real-time simulation of local scour calculation and foundation dynamic and stability analysis.

### BRIEF DESCRIPTION OF THE DRAWINGS

FIG. 1 is a flowchart of calculation of a foundation scour fluid-solid-soil coupling simulation method based on SPH-DEM coupling and a multiphase flow theory according to the present disclosure;

FIG. 2 is a diagram of a fluid particle distribution and retrieval mechanism simulated by the present disclosure;

FIG. 3 is a diagram of a DEM rigid particle contact mechanism simulated by the present disclosure;

FIG. 4 is a diagram of sediment type classification of scour calculation simulated by the present disclosure; and

FIG. 5 is an enlarged view of an interface of a bed load and a suspended load.

In the figures, 1 denotes fluid particles;
2 denotes a center fluid particle to be searched;
3 denotes a kernel function radius h;
4 denotes a center of mass of a DEM rigid particle i;
5 denotes a center of mass of a DEM rigid particle j;
6 denotes a normal spring in a contact part of the particle i and the particle j, having the rigidity of Kₙ, where a radial contact length is a radial length of an overlapping part;
7 denotes normal contact damping γₙ of the contact part of the particle i and the particle j;
8 denotes a tangential spring in the contact part of the particle i and the particle j, having the rigidity of Kₜ, where a tangential contact length is a tangential length of the overlapping part;
9 denotes tangential contact damping γₜ of the contact part of the particle i and the particle j;
10 denotes an ordinary soil body;
11 denotes a yield soil body;
12 denotes a bed load; and
13 denotes a suspended load.

### DETAILED DESCRIPTION

Implementations of the present disclosure are described in detail, and examples of the implementations are shown in the drawings. The following implementations described in reference to the drawings are exemplary, are only used to explain the present disclosure but are not to be construed as limiting the present disclosure.

The present disclosure belongs to secondary development based on an SPH multiphase flow algorithm and a DEM computational theory. Thus, the default precondition of the present disclosure is that the SPH multiphase flow algorithm and the DEM computational theory are known or open-source. The solving of partial differential equations such as a fluid control equation and a DEM particle motion control equation is not within the discussion scope of the present disclosure, and related variables can be manually extracted or obtained.

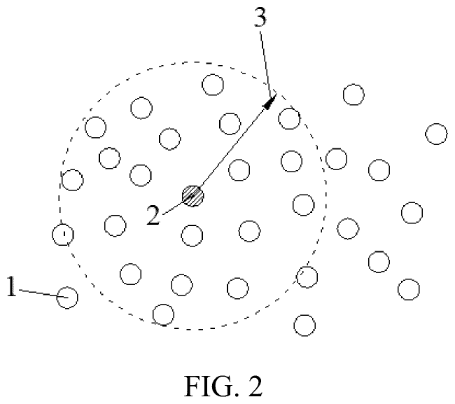

FIG. 2 illustrates a fluid particle distribution and retrieval mechanism according to the present disclosure, 1 denotes fluid particles, 2 denotes a center fluid particle to be searched, and 3 denotes a kernel function radius h.

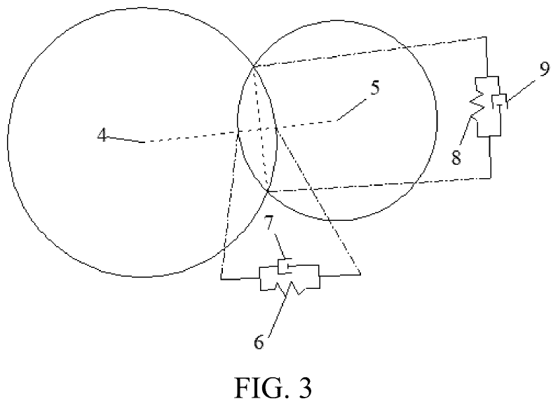

FIG. 3 illustrates a DEM rigid particle contact model according to the present disclosure, where 4 denotes a center of mass of a DEM rigid particle i; 5 denotes a center of mass of a DEM rigid particle j; 6 denotes a normal spring in a contact part of the particle i and the particle j, having the rigidity of Kₙ, and a radial contact length is a radial length of an overlapping part; 7 denotes normal contact damping γₙ of the contact part of the particle i and the particle j; 8 denotes a tangential spring in the contact part of the particle i and the particle j, having the rigidity of Kₜ, and a tangential contact length is a tangential length of the overlapping part; and 9 denotes tangential contact damping γₜ of the contact part of the particle i and the particle j.

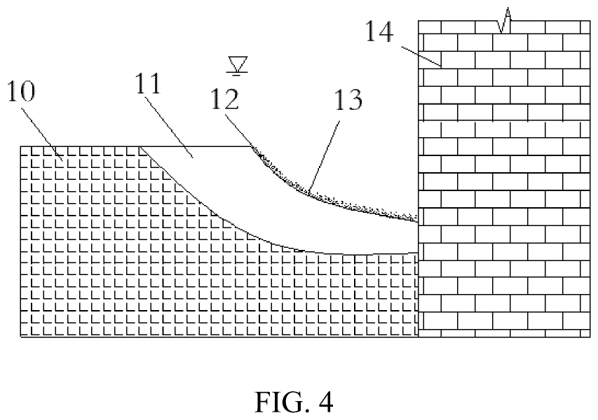

FIG. 4 illustrates a sediment distribution situation according to the present disclosure, a riverbed part is an ordinary soil body 10, a yield soil body 11 is arranged below a scour pit, a bed load 12 and a suspended load 13 are distributed in the scour pit, the bed load 12 is adjacent to the yield soil body 13, and the suspended load 13 is distributed above the bed load 12.

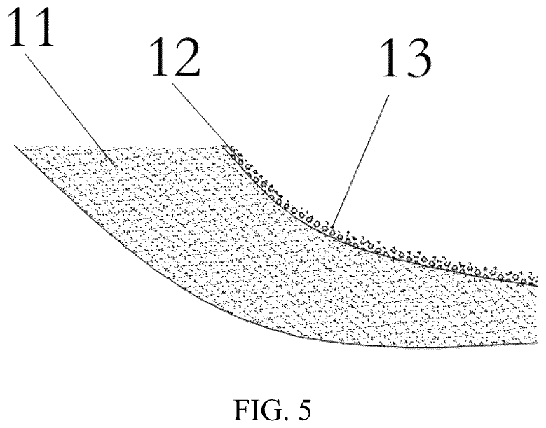

FIG. 5 is an enlarged view of an interface of the bed load and the suspended load.

A specific implementation method of the present disclosure is described with SPH open-source computational software Dualsphysics as an example, the solving of the partial differential equations such as the fluid control equation and the DEM motion control equation is processed by corresponding algorithm modules, and related variables can be manually obtained.

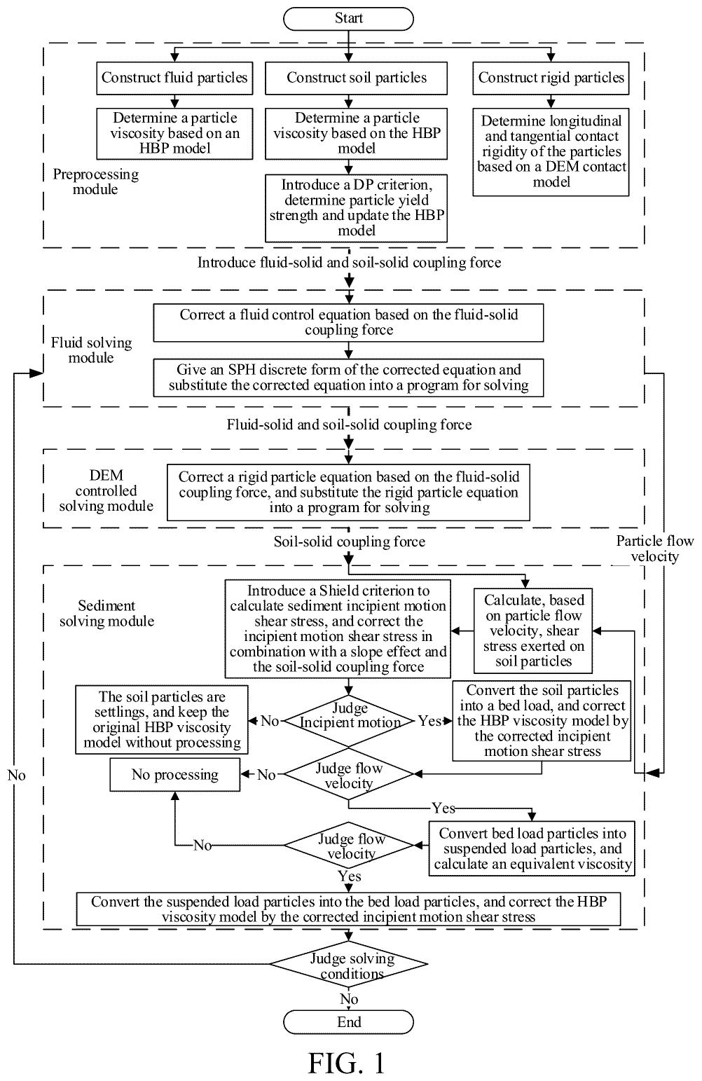

In combination with FIG. 1, a specific calculation process of a foundation scour fluid-solid-soil coupling simulation method based on SPH-DEM coupling and a multiphase flow theory according to the present disclosure is as below:

### Preprocessing Module:

Step 1: A particle model is constructed, fluid particles and bed material particles are set based on the multiphase flow theory, and rigid particles are set based on a DEM theory, where specific steps are as below:
Step 1.1: A fluid particle model and a soil particle model are respectively constructed based on a multiphase flow basic principle, the fluid particle model is set as Newtonian fluid, the soil particle model is set as non-Newtonian fluid, and soil viscosity HBP is determined based on an HBP model:

$${μ}_{HBP} = \frac{\vert {τ}_{c} \vert}{\sqrt{{II}_{D}}} [ 1 - {e}^{- m \sqrt{{II}_{D}}} ] + 2 μ {\vert 4 {II}_{D} \vert}^{\frac{n - 1}{2}}$$

where τ_{c} denotes yield stress of a model material, II_{D} denotes a second invariant of a fluid strain rate tensor, m denotes a stress exponent growth coefficient, μ denotes a water viscosity, and n denotes an exponent associated with shear stress.
Step 1.2: A DP yield criterion is introduced to calculate specific material yield stress τ_{y}:

$$\vert {τ}_{y} \vert = α p + β$$

where ρ denotes hydrostatic pressure exerted on saturated sediment particles, and α and β are given by Mohr-Coulomb yield criterion parameters and calculated as below:

$$α = \frac{2 sin θ}{\sqrt{3} ( 3 - sin θ )} , β = \frac{6 c sin θ}{\sqrt{3} ( 3 - sin θ )}$$

where θ denotes an internal friction angle, and c denotes soil cohesion.
Step 1.3: The specific material yield stress τ_{y} obtained in step 1.2 is substituted into the calculation formula of the soil viscosity μ_{HBP} in step 1.1 to replace the model material yield stress τ_{c}, and a soil viscosity calculation model is established.
Step 1.4: The rigid particles are set based on the DEM theory, a normal contact rigidity Kₙ, normal contact damping γₙ, a tangential contact rigidity Kₜ and tangential contact damping γₜ among the rigid particles are determined:

$$\{ \begin{matrix}{K}_{n , ij} = \frac{4}{3} {E}^{*} \sqrt{{R}^{*}} ; {γ}_{n , ij} = {C}_{n} \sqrt{6 {M}^{*} {E}^{*} \sqrt{{R}^{*}}} ; \\ {K}_{t , ij} = \frac{2}{7} {K}_{n , ij} ; {γ}_{t , ij} = \frac{2}{7} {γ}_{n , ij}\end{matrix}$$

where Cₙ=1*10⁻⁵, , K_{n,ij} denotes the normal contact rigidity between the DEM rigid particle i and the rigid particle j, and Kₜ,ij, γ_{n,ij} and γ_{t,ij} are defined in the same way; and E* denotes an equivalent elasticity modulus, R* denotes an equivalent particle radius, and M*denotes an equivalent mass, which are respectively calculated as below:

$$\frac{1}{{E}^{*}} = \frac{1 - {μ}_{i}^{2}}{{E}_{i}} + \frac{1 - {μ}_{j}^{2}}{{E}_{j}} ; {R}^{*} = \frac{{r}_{i} {r}_{j}}{{r}_{i} + {r}_{j}} ; {M}^{*} = \frac{{m}_{i} {m}_{j}}{{m}_{i} + {m}_{j}}$$

where Eᵢ and Eⱼ respectively denote the elasticity modulus of the material assigned by the DEM rigid particle i and the rigid particle j, μᵢ and μⱼ respectively denote the Poisson's ratio of the material assigned by the DEM rigid particle i and the rigid particle j, rᵢ and rⱼ respectively denote the radius of the DEM rigid particle i and the radius of the rigid particle j, and mᵢ and mⱼ respectively denote the mass of the DEM rigid particle i and the mass of the rigid particle j.

Step 1.5: Normal contact force Fₙ and tangential contact force Fₜ are determined according to contact rigidity among the rigid particles:

$$\{ \begin{matrix}{F}_{n} = {K}_{n , ij} {δ}_{ij}^{1.5} {e}_{ij} - {γ}_{ij} {δ}_{ij}^{0.25} {δ}_{ij}^{\vert} {e}_{ij} \\ {F}_{t} = min ( {K}_{t , ij} {δ}_{ij}^{t} {e}_{ij}^{t} - {γ}_{ij} {δ}_{ij}^{t} {e}_{ij}^{t} , {u}_{f} \vert {F}_{n} \vert tanh ( 8 {δ}_{ij}^{t} ) {e}_{ij}^{t} )\end{matrix}$$

where δᵢⱼ and δᵢⱼ^{t} respectively denote a radial contact distance and a tangential contact distance of the DEM rigid particle i and the rigid particle j; eᵢⱼ denotes a unit vector pointing from the center of mass of the DEM rigid particle i to the center of mass of the rigid particle j; δᵢⱼ and δᵢⱼ^{t} respectively denote a radial deformation rate and a tangential deformation rate of the DEM rigid particle i and the rigid particle j, δᵢⱼ=vᵢⱼ,δᵢⱼ^{t}=vᵢⱼ^{t}, vᵢⱼ and vᵢⱼ^{t} respectively denote a radial relative velocity and a tangential relative velocity of the DEM rigid particle i and the rigid particle j, and μ_{f} denotes a friction coefficient between the DEM rigid particle i and the rigid particle j.

### Fluid Solving Module:

Step 2: A fluid-solid coupling theory is introduced based on the particle model obtained in step 1 to correct the fluid control equation, and controlled solving of the fluid particles is performed, where specific steps are as below:
Step 2.1: Particle fluid-solid coupling force F_{fs} is introduced, and a fluid momentum conservation equation is corrected as:

$$\frac{du}{dt} = - \frac{1}{ρ} ∇ P + υ {∇}^{2} u + g + {F}_{fs}$$

where in the equation, μ denotes a fluid velocity vector, P is a fluid pressure item, v denotes a fluid viscosity, g is a fluid gravity item, and the rest of symbols are the same as above.
Step 2.2: A discrete form of the control equation obtained in step 2.1 is given based on a kernel function theory of an SPH algorithm:

$$\frac{{du}_{a}}{dt} = - {\sum }_{b} {m}_{b} ( \frac{{P}_{b} + {P}_{a}}{{ρ}_{b} \cdot {ρ}_{a}} ) {∇}_{a} {W}_{ab} + g + {\sum }_{b} {m}_{b} ( \frac{4 {μ}_{0} {r}_{ab} \cdot {∇}_{a} {W}_{ab}}{( {ρ}_{a} + {ρ}_{b} ) ( {r}_{ab}^{2} + {η}^{2} )} ) {u}_{ab} + {\sum }_{b} {m}_{b} ( \frac{{τ}_{ij}^{b}}{{ρ}_{b}^{2}} + \frac{{τ}_{ij}^{a}}{{ρ}_{a}^{2}} ) {∇}_{a} {W}_{ab} + {m}_{s} {\sum }_{f} {m}_{f} ( \frac{{P}_{s}}{{ρ}_{s}^{2}} + \frac{{P}_{f}}{{ρ}_{f}^{2}} ) {∇}_{s} {W}_{sf}$$

where ∇ is a Hamiltonian operator, the subscript α denotes a center particle, the subscript b denotes a neighbor particle, W_{ab} is a kernel function

$$W ( {r}_{i} - {r}_{j} , h ) = \frac{21}{16 π {h}^{3}} {( 1 - \frac{q}{2} )}^{4} ( 2 q + 1 )$$

$$0 \leq q \leq 2$$

with a particle a as a retrieval center, rₐ and r_{b} respectively denote position vectors of the center particle and the neighbor particle, q is a ratio of a particle spacing to a smooth length, and h denotes the smooth length; and μ₀ denotes a motion viscosity, τᵢⱼ denotes a fluid SPS stress vector, m_{f} and P_{f} respectively denote the mass and the pressure of fluid particles searched within the kernel function radius by a rigid particles, mₛ and Pₛ respectively denote the equivalent mass and pressure of the rigid particle,

$${m}_{s} = {\sum }_{f} \frac{{m}_{f}^{2}}{{ρ}_{f}} {W}_{sf} and {P}_{s} = {\sum }_{f} \frac{{m}_{f} {P}_{f}}{{ρ}_{f}} {W}_{sf} .$$

### DEM Controlled Solving Module:

Step 3: Based on the particle model obtained in step 1, the rigid particle control equation is corrected and solved by combining the Newton's second law and introducing the particle fluid-solid coupling force F_{fs} obtained in step 2:

$${m}_{a} \frac{{dv}_{a}}{dt} = G + {F}_{fs} + {F}_{n} + {F}_{t}$$

where mₐ and vₐ respectively denote a mass and a velocity vector of the rigid particle α, G denotes a gravity vector of the rigid particle a, and the rest of symbols are the same as above.

### Sediment Solving Module:

Step 4: Based on the particle model obtained in step 1, a sediment particle Shield criterion is introduced, a sediment incipient motion model is corrected in combination with the fluid-soil coupling force obtained in step 1 and the solid-soil coupling force obtained in step 2, and foundation scour controlled solving is performed, where specific steps are as below:
Step 4.1: Based on the fluid particle velocity μ obtained in step 2, an Einstein logarithmic flow velocity distribution formula is introduced to calculate fluid shear stress τ_{b} exerted on soil particles:

$$\frac{{τ}_{b}}{ρ} = {( κ d )}^{2} {( \frac{Δ u}{d} )}^{2}$$

where d denotes a characteristic particle size of the particles; Δu denotes a velocity difference of sediment particles and nearby water particles, κ denotes a von Karman constant being 0.41, and ρ denotes a sediment particle density.
Step 4.2: Based on the soil particle viscosity μ_{HBP} model obtained in step 1.1, the sediment particle Shield criterion is introduced to judge an incipient motion state of the sediment particles, and sediment incipient motion critical stress τ_{cr,0} is calculated:

$${τ}_{bcr} = {θ}_{cr} \cdot ( {ρ}_{s} - ρ ) gd$$

where θ_{cr} denotes a critical Shields parameter only related to sediment parameters, ρₛ denotes a saturated sediment density, ρ denotes a water density, g denotes a gravitational acceleration, and d denotes a particle size of the soil particles.
Step 4.3: Based on the sediment incipient motion critical stress τ_{cr,0} obtained in step 4.2, the fluid-solid coupling force F_{fs} of the sediment particles and the rigid particles obtained in step 2 is introduced to calculate corrected sediment incipient motion critical stress τ_{cr} considering an external load and a side slope effect:

$$\frac{{τ}_{cr}}{{τ}_{cr , 0}} = {\frac{\sqrt{\begin{matrix}{( {f}_{1} + η {tan}^{2} ϕ {f}_{2} )}^{2} + \\ ( 1 - {η}^{2} {tan}^{4} ϕ ) {f}_{2}^{2} + ( 1 - {η}^{2} {tan}^{2} ϕ ) {f}_{3}^{2}\end{matrix}} - {ηtan}^{2} ϕ {f}_{1} - f}{( 1 - η tan ϕ ) W}}_{2}$$

$$\{ \begin{matrix}{f}_{1} = W cos γ - \vec{P} \cdot \vec{n} \\ {f}_{2} = \vec{P} \cdot \vec{f} - W \cdot {w}_{z} \\ {f}_{3} = \vec{P} + W sin γ \vec{{e}_{wt}}\end{matrix}$$

where P is a modulus of F_{fs}, η=0.7, \vec{ƒ} is a unit vector in a flow velocity direction, W denotes gravity exerted on the sediment particles, α, β, and γ respectively denote an included angle between a slope surface normal vector and an X-axis direction, an included angle between the slope surface normal vector and a Y-axis direction, and an included angle between the slope surface normal vector and a Z-axis direction,

$$\vec{n} = \frac{1}{ℓ} ( tan α , tan β , 1 ) ,$$

[symbol]

\sqrt{1+tan²α+tan²β}=(cosγ)⁻¹, wᵢ is a component of \vec{ƒ} in the X-axis direction, the Y-axis direction and the Z-axis direction, \vec{e_{wt}} is a unit vector component of the gravity in a slope surface direction, and Ø denotes an internal friction angle of the sediment particles.
Step 4.4: The incipient motion state of the sediment particles is judged based on the fluid shear stress τ_{b} obtained in step 4.1 and the corrected sediment incipient motion critical stress τ_{cr} obtained in step 4.3, where if τ_{cr}≤τ_{b} is satisfied, τ_{cr} is substituted into the formula obtained in step 1.1 to replace the yield stress τ_{c}, a bed material particle viscosity μ_{HBP} is updated to make the bed material particle into a bed load particle, and if the condition is not satisfied, processing is performed according to step 1.2 and step 1.3.

Step 4.5: According to the bed load particles obtained in step 4.4, a Mastbergen formula is introduced to calculate a critical flow velocity μ_{lift} at which the bed load is converted into the suspended load:

$${u}_{lift} = {α}_{i} {n}_{s} {{d}_{*}^{0.3} ( {θ}_{b} - {θ}_{cr} )}^{1.5} \sqrt{\frac{d ( {ρ}_{s} - ρ ) g}{ρ}}$$

where αᵢ denotes a sediment transport coefficient, nₛ denotes a bed surface normal vector, d. denotes a sediment particle size coefficient,

$${d}_{*} = {{d}_{50} [ \frac{ρ ( {ρ}_{s} - ρ ) g}{{μ}^{2}} ]}^{1 / 3} ,$$

ρₛ denotes a saturated sediment density, ρ denotes a water density, g denotes a gravitational acceleration, d denotes a particle size of the soil particles, μ denotes a water viscosity, θ_{b} denotes an actual Shields parameter of the soil particles, and θ_{cr} denotes a critical Shields parameter.

If an actual flow velocity μ≥μ_{lift} of the fluid particles is satisfied, the fluid particles are converted into the suspended load particles, and an equivalent viscosity μ_{lift} is calculated to replace μ_{HBP}:

$${μ}_{lift} = μ e \frac{0.5 {C}_{v}}{1 - \frac{39}{64} {C}_{v}}$$

where μ denotes a water viscosity, and Cy denotes a sediment particle concentration within the kernel function radius.

If the condition is not satisfied, no processing is performed.
Step 4.6: According to the suspended load particles obtained in step 4.5, the Mastbergen formula is introduced to calculate a critical flow velocity μₛₑₜ at which the suspended load is converted into the bed load:

$${u}_{set} = \frac{μ}{d} [ {( 10.3 {6}^{2} + 1049 {d}_{*}^{3} )}^{0.5} - 10.36 ]$$

where μ denotes a water viscosity, d denotes a particle size of the soil particles, and d. denotes a sediment particle size coefficient.

If the actual flow velocity μ≤μₛₑₜ of the particles is satisfied, the particles are converted into the bed load particles and processed according to step 4.4, and if the condition is not satisfied, no processing is performed.

The above specific steps are only specific descriptions when a scour module runs for a time step. In actual operation, the cycle is required to be repeated till the solving finish time is reached.

The above method steps and basic formula principles may also be loaded onto other open-source SPH computational software, such that a series of operation steps are performed on a computer or another programmable device, thereby realizing scour numerical simulation, and accordingly, instructions are executed on the computer or the another programmable device to implement functions or steps assigned in one or more processes in a flowchart.

The above embodiments are merely used to describe the technical concept of the present disclosure but cannot be construed as limiting the scope of protection of the present disclosure. Any modification made on the basis of the technical solution according to the technical concept proposed by the present disclosure shall fall within the scope of protection of the present disclosure.

What is claimed is:

1. A foundation scour fluid-solid-soil coupling simulation method based on SPH-DEM coupling and a multiphase flow theory, comprising following steps:
step 1: constructing a particle model, setting fluid particles and bed material particles based on the multiphase flow theory, and setting rigid particles based on a DEM theory, specific steps comprising as below:
step 1.1: respectively constructing a fluid particle model and a soil particle model based on a multiphase flow basic principle, setting the fluid particle model as Newtonian fluid, setting the soil particle model as non-Newtonian fluid, and determining a soil viscosity μ_{HBP} based on an HBP model,
$${μ}_{HBP} = \frac{\vert {τ}_{c} \vert}{\sqrt{{II}_{D}}} [ 1 - {e}^{m \sqrt{{II}_{D}}} ] + 2 μ {\vert 4 {II}_{D} \vert}^{\frac{n - 1}{2}}$$
wherein τ_{c} denotes yield stress of a model material, II_{D} denotes a second invariant of a fluid strain rate tensor, m denotes a stress exponent growth coefficient, μ denotes a water viscosity, and n denotes an exponent associated with shear stress;
step 1.2: introducing a DP yield criterion to calculate specific material yield stress τ_{y};
step 1.3: substituting the specific material yield stress τ_{y} obtained in step 1.2 into the calculation formula of the soil viscosity μ_{HBP} in step 1.1 to replace the model material yield stress τ_{c}, and establishing a soil viscosity calculation model;
step 1.4: setting the rigid particles based on the DEM theory, and determining a normal contact rigidity Kₙ, normal contact damping γₙ, a tangential contact rigidity Kₜ and tangential contact damping γₜ among the rigid particles; and
step 1.5: calculating normal contact force F, and tangential contact force F, based on the normal contact rigidity Kₙ, the normal contact damping γₙ, the tangential contact rigidity Kₜ and the tangential contact damping γₜ among the rigid particles obtained in step 1.4;
step 2: introducing a fluid-solid coupling theory based on the particle model obtained in step 1 to correct a fluid control equation, and performing controlled solving of the fluid particles, specific steps comprising as below:
step 2.1: introducing particle fluid-solid coupling force F_{fs}, and correcting a fluid momentum conservation equation; and
step 2.2: giving a discrete form of the fluid momentum conservation equation obtained in step 2.1, based on a kernel function theory of an SPH algorithm;
step 3: based on the particle model obtained in step 1, correcting and solving the rigid particle control equation by combining the Newton's second law and considering the particle fluid-solid coupling force F_{fs} obtained in step 2;
step 4: based on the particle model obtained in step 1, introducing a sediment particle Shield criterion, correcting a sediment incipient motion model in combination with the fluid-soil coupling force obtained in step 1 and the solid-soil coupling force obtained in step 2, and performing foundation scour controlled solving, specific steps comprising as below:
step 4.1: based on the fluid particle velocity μ obtained based on the momentum equation in step 2, introducing an Einstein logarithmic flow velocity distribution formula to calculate fluid shear stress τ_{b} exerted on soil particles;
step 4.2: based on the soil particle viscosity μ_{HBP} model obtained in step 1.1, introducing the sediment particle Shield criterion to calculate sediment incipient motion critical stress τ_{cr,0};
step 4.3: based on the sediment incipient motion critical stress τ_{cr,0} obtained in step 4.2, introducing the fluid-solid coupling force F_{fs} of the sediment particles and the rigid particles obtained in step 2 to calculate corrected sediment incipient motion critical stress τ_{cr} considering an external load and a side slope effect;
step 4.4: judging the incipient motion state of the sediment particles based on the fluid shear stress τ_{b} obtained in step 4.1 and the corrected sediment incipient motion critical stress τ_{cr} obtained in step 4.3, wherein if τ_{cr}<TD is satisfied, τ_{cr} is substituted into the formula in step 1.1 to replace the yield stress τ_{c}, a bed material particle viscosity μ_{HBP} is updated to make the bed material particle into a bed load particle, and if the condition is not satisfied, processing is performed according to step 1.2 and step 1.3;
step 4.5: according to the bed load particles obtained in step 4.4, introducing a Mastbergen formula to calculate a critical flow velocity μ_{lift} at which a bed load is converted into a suspended load, wherein if a flow velocity μ≥μ_{lift} of the fluid particles is satisfied, the fluid particles are converted into suspended load particles, and an equivalent viscosity μ_{lift} is calculated to replace the bed material particle viscosity μ_{HBP}, and if the condition is not satisfied, no processing is performed; and
step 4.6: according to the suspended load particles obtained in step 4.5, introducing the Mastbergen formula to calculate a critical flow velocity μₛₑₜ at which the suspended load is converted into the bed load, wherein if the actual flow velocity us μₛₑₜ of the particles is satisfied, the particles are converted into the bed load particles and processed according to step 4.4, and if the condition is not satisfied, no processing is performed; and
step 5: repeating step 1 to step 4 until solving is completed.

2. The foundation scour fluid-solid-soil coupling simulation method based on the SPH-DEM coupling and the multiphase flow theory according to claim 1, wherein in step 1.2, the material yield stress τ_{y} is calculated as below:
$$\vert {τ}_{y} \vert = α p + β$$
wherein ρ denotes hydrostatic pressure exerted on saturated sediment particles, and a and β are given by Mohr-Coulomb yield criterion parameters, and calculation formulas are as below:
$$α \frac{- 2 sin θ}{\sqrt{3} ( 3 - sin θ )} ,$$
$$β = \frac{6 c sin θ}{\sqrt{3} ( 3 - sin θ )}$$
wherein θ denotes an internal friction angle, and c denotes soil cohesion.

3. The foundation scour fluid-solid-soil coupling simulation method based on SPH-DEM coupling and the multiphase flow theory according to claim 1, wherein in step 1.4, the normal contact rigidity Kₙ, the normal contact damping γₙ, the tangential contact rigidity Kₜ and the tangential contact damping γₜ among the rigid particles are calculated as below:
$$\{ \begin{matrix}{K}_{n , ij} = \frac{4}{3} {E}^{*} \sqrt{{R}^{*}} ; {γ}_{n , ij} = {C}_{n} \sqrt{6 {M}^{*} {E}^{*} \sqrt{{R}^{*}}} ; \\ {K}_{t , ij} = \frac{2}{7} {K}_{n , ij} ; {γ}_{t , ij} = \frac{2}{7} {γ}_{n , ij}\end{matrix}$$
wherein Cₙ=1*10⁻⁵, , K_{n,ij} denotes the normal contact rigidity between the DEM rigid particle i and the rigid particle j, and K_{t,ij}, γ_{n,ij} and γ_{t,ij} are defined in the same way; and E* denotes an equivalent elasticity modulus, R* denotes an equivalent particle radius, and M* denotes an equivalent mass, which are respectively calculated as below:
$$\frac{1}{{E}^{*}} = \frac{1 - {μ}_{i}^{2}}{{E}_{i}} + \frac{1 - {μ}_{j}^{2}}{{E}_{j}} ;$$
$${R}^{*} = \frac{{r}_{i} {r}_{j}}{{r}_{i} + {r}_{j}} ;$$
$${M}^{*} = \frac{{m}_{i} {m}_{j}}{{m}_{i} + {m}_{j}}$$
wherein Eᵢ and Eⱼ respectively denote the elasticity modulus of the material assigned by the DEM rigid particle i and the rigid particle j;
μᵢ and μⱼ respectively denote the Poisson's ratio of the material assigned by the DEM rigid particle i and the rigid particle j;
rᵢ and rⱼ respectively denote the radius of the DEM rigid particle i and the radius of the rigid particle j; and
mᵢ and mⱼ respectively denote the mass of the DEM rigid particle i and the mass of the rigid particle j.

4. The foundation scour fluid-solid-soil coupling simulation method based on the SPH-DEM coupling and the multiphase flow theory according to claim 1, wherein in step 2.1, the fluid momentum conservation equation is corrected as:
$$\frac{du}{dt} = - \frac{1}{ρ} ∇ P + υ {∇}^{2} u + g + {F}_{fs}$$
wherein in the equation, u denotes a fluid velocity vector, P is a fluid pressure item, v denotes a fluid viscosity, g is a fluid gravity item, and the rest of symbols are the same as above.

5. The foundation scour fluid-solid-soil coupling simulation method based on the SPH-DEM coupling and the multiphase flow theory according to claim 1, wherein in step 2.2, the discrete form of the control equation obtained in step 2.1 is:
$$\frac{{du}_{a}}{dt} = - {\sum }_{b} {m}_{b} ( \frac{{P}_{b} + {P}_{a}}{{ρ}_{b} \cdot {ρ}_{a}} ) {∇}_{a} {W}_{ab} + g + {\sum }_{b} {m}_{b} ( \frac{4 {μ}_{0} {r}_{ab} \cdot {∇}_{a} {W}_{ab}}{( {ρ}_{a} + {ρ}_{b} ) ( {r}_{ab}^{2} + {η}^{2} )} ) {u}_{ab} + {\sum }_{b} {m}_{b} ( \frac{{τ}_{ij}^{b}}{{ρ}_{b}^{2}} + \frac{{τ}_{ij}^{a}}{{ρ}_{a}^{2}} ) {∇}_{a} {W}_{ab} + {m}_{s} {\sum }_{f} {m}_{f} ( \frac{{P}_{s}}{{ρ}_{s}^{2}} + \frac{{P}_{f}}{{ρ}_{f}^{2}} ) {∇}_{s} {W}_{sf}$$
wherein ∇ is a Hamiltonian operator, the subscript α denotes a center particle, the subscript b denotes a neighbor particle, W_{ab} is a kernel function
$$W ( {r}_{a} - {r}_{b} , h ) = \frac{21}{16 π {h}^{3}} {( 1 - \frac{q}{2} )}^{4} ( 2 q + 1 )$$
$$0 \leq q \leq 2$$
with a particle a as a retrieval center, rₐ and r_{b} respectively denote position vectors of the center particle and the neighbor particle, q is a ratio of a particle spacing to a smooth length, and h denotes the smooth length;
μ₀ denotes a motion viscosity;
τᵢⱼ denotes a fluid SPS stress vector;
m_{f} and ρ_{f} respectively denote the mass and the pressure of fluid particles searched within the kernel function radius by a rigid particle s,
mₛ and ρₛ respectively denote the equivalent mass and the pressure of the rigid particles,
$${m}_{s} = {Σ}_{f} \frac{{{m}^{2}}_{f}}{{ρ}_{f}} {W}_{sf} ;$$
$${P}_{s} = {Σ}_{f} \frac{{m}_{f} {P}_{f}}{{ρ}_{f}} {W}_{sf} ;$$
$$and$$
the rest of variables are the same as above.

6. The foundation scour fluid-solid-soil coupling simulation method based on the SPH-DEM coupling and the multiphase flow theory according to claim 1, wherein in step 3, the rigid particle control equation is corrected as:
$${m}_{a} \frac{{dv}_{a}}{dt} = G + {F}_{fs} + {F}_{n} + {F}_{t}$$
wherein mₐ and vₐ respectively denote a mass and a velocity vector of the rigid particle α, G denotes a gravity vector of the rigid particle α, and the rest of symbols are the same as above.

7. The foundation scour fluid-solid-soil coupling simulation method based on the SPH-DEM coupling and the multiphase flow theory according to claim 1, wherein in step 4.1, the fluid shear stress τ_{b} is calculated as:
$$\frac{{τ}_{b}}{ρ} = {( κ d )}^{2} {( \frac{Δ u}{d} )}^{2}$$
wherein d denotes a characteristic particle size of the particles; Δu denotes a velocity difference of sediment particles and nearby water particles, κ denotes a von Karman constant being 0.41, and ρ denotes a sediment particle density.

8. The foundation scour fluid-solid-soil coupling simulation method based on the SPH-DEM coupling and the multiphase flow theory according to claim 1, wherein in step 4.2, the calculation formula of the sediment incipient motion critical stress τ_{cr,0} is:
$${τ}_{cr , 0} = {θ}_{cr} \cdot ( {ρ}_{s} - ρ ) gd$$
wherein θ_{cr} denotes a critical Shields parameter only related to sediment parameters, ρₛ denotes a saturated sediment density, ρ denotes a water density, g denotes a gravitational acceleration, and d denotes a particle size of the soil particles.

9. The foundation scour fluid-solid-soil coupling simulation method based on the SPH-DEM coupling and the multiphase flow theory according to claim 1, wherein in step 4.3, the corrected sediment incipient motion critical stress τ_{cr} is calculated as:
$$\frac{{τ}_{cr}}{{τ}_{cr , 0}} = \frac{\sqrt{{( {f}_{1} + η {tan}^{2} ϕ {f}_{2} )}^{2} + ( 1 - {η}^{2} {tan}^{4} ϕ ) {f}_{2}^{2} + ( 1 - {η}^{2} {tan}^{2} ϕ ) {f}_{3}^{2}} - \text{} η {tan}^{2} ϕ {f}_{1} - {f}_{2}}{( 1 - η tan ϕ ) W}$$
$$\{ \begin{matrix}{f}_{1} = W cos γ - \vec{P} \cdot \vec{n} \\ {f}_{2} = \vec{P} \cdot \vec{f} - W \cdot {w}_{z} \\ {f}_{3} = \vec{P} + W sin γ \vec{{e}_{wt}}\end{matrix}$$
wherein P is a modulus of F_{fs}, η=0.7, \vec{ƒ} is a unit vector in a flow velocity direction, W denotes gravity exerted on the sediment particles, α, β, and γ respectively denote an included angle between a slope surface normal vector and an X-axis direction, an included angle between the slope surface normal vector and a Y-axis direction, and an included angle between the slope surface normal vector and a Z-axis direction,
$$\vec{n} = \frac{1}{ℓ} ( tan α , tan β , 1 ) ,$$
l=\sqrt{1+tan²α+tan²β}=(cosγ)⁻¹, wᵢ is a component of \vec{ƒ} in the X-axis direction, the Y-axis direction and the Z-axis direction, \vec{e_{wt}} is a unit vector component of the gravity in a slope surface direction, and Ø denotes an internal friction angle of the sediment particles.

10. The foundation scour fluid-solid-soil coupling simulation method based on the SPH-DEM coupling and the multiphase flow theory according to claim 1, wherein in step 4.5, the critical flow velocity μ_{lift} at which the bed load is converted into the suspended load is calculated as:
$${u}_{lift} = {α}_{i} {n}_{s} {{d}_{*}^{0.3} ( {θ}_{b} - {θ}_{cr} )}^{1.5} \sqrt{\frac{d ( {ρ}_{s} - ρ ) g}{ρ}}$$
wherein αᵢ denotes a sediment transport coefficient, nₛ denotes a bed surface normal vector, da denotes a sediment particle size coefficient,
$${d}_{*} = {{d}_{50} [ \frac{ρ ( {ρ}_{s} - ρ ) g}{{μ}^{2}} ]}^{1 / 3} ,$$
ρₛ denotes a saturated sediment density, ρ denotes a water density, g denotes a gravitational acceleration, d denotes a particle size of the soil particles, θ_{b} denotes an actual Shields parameter of the soil particles, and θ_{cr} denotes a critical Shields parameter; and
the equivalent viscosity μ_{lift} is calculated as:
$${μ}_{lift} = μ e \frac{0.5 {C}_{v}}{1 - \frac{39}{64} {C}_{v}}$$
wherein μ denotes a water viscosity, and Cᵥ denotes a sediment particle concentration within the kernel function radius; and
instep 4.6, the calculation formula of the critical flow velocity μₛₑₜ is:
$${u}_{set} = \frac{μ}{d} [ {( {10.36}^{2} + 1.049 {d}_{*}^{3} )}^{0.5} - 10.36 ]$$
wherein μ denotes a water viscosity, d denotes a particle size of the soil particles, and d, denotes a sediment particle size coefficient.
